(19) United States
(12) Patent Application Publication
(10) Pub. No.: US 2020/0065596 A1
(43) Pub. Date: Feb. 27, 2020

(54) CONTROL METHOD OF AUTONOMOUS VEHICLE

(71) Applicant: LG ELECTRONICS INC., Seoul (KR)

(72) Inventors: Jichan MAENG, Seoul (KR); Beomoh KIM, Seoul (KR); Wonho SHIN, Seoul (KR)

(73) Assignee: LG ELECTRONICS INC., Seoul (KR)

(21) Appl. No.: 16/667,643

(22) Filed: Oct. 29, 2019

(30) Foreign Application Priority Data
Aug. 21, 2019 (KR) 10-2019-0102208

(51) Int. Cl. G06K 9/00; B60W 40/09; B60J 3/02; H04W 4/40; H04W 72/04; H04W 72/12

(52) U.S. Cl. CPC G06K 9/00845; G06K 9/00617; B60W 40/09; H04W 72/1289; H04W 4/40; H04W 72/042; B60J 3/02

(57) ABSTRACT

A method of controlling of an autonomous vehicle according to an embodiment of the present disclosure, the method comprising the steps of: acquiring state information of a driver from a sensor mounted inside the vehicle; determining a glare state of the driver based on state information of the driver; operating a primary light source blocking when recognizing a glare state of the driver; operating, by the primary light source blocking, a light source blocking device mounted on the vehicle at the moment of recognizing the glare state of the driver, and tracking a gaze direction of the driver through a first image to acquire the gaze direction of the driver; and operating secondary light source blocking, when the acquired gaze direction of the driver is outside a predetermined range. The autonomous vehicle according to the present disclosure may be associated with an artificial intelligence module, a drone (UAV), a robot, an AR device, a VR device, a device related to 5G service, etc.

Pursuant to 35 U.S.C § 119(a), this application claims the benefit of earlier filing date and right of priority to Korean Patent Application No. 10-2019-0102208, filed on Aug. 21, 2019, the contents of which are all hereby incorporated by reference herein in its entirety.

### BACKGROUND OF THE INVENTION

### Field of the invention

The present disclosure relates to a control method of an autonomous vehicle, and more particularly, to a control method of an autonomous vehicle capable of blocking driving disturbance of a driver by an external light source (sunlight, vehicle headlights at night in an opposite side, etc.) of the autonomous vehicle.

### Related Art

Automatic driving is to automatically perform a variety of operations required during the driving of the vehicle, for example, an autonomous vehicle can run on the road by itself without operating the steering wheel, accelerator pedal, brake, and the like by a driver. For the automatic driving of a vehicle, a technology for automatically maintaining a distance between vehicles, a technology for indicating lane departure and lane keeping, a technology for indicating objects sensed in the rear and side area and the like may be used. Various techniques for the automatic driving may be performed through surrounding image information that is acquired in a vehicle.

The autonomous vehicle may control whether the distance between the preceding vehicles is maintained, the vehicle is in the departure and the vehicle is the lane keeping based on the image captured from the front of the driving vehicle.

Meanwhile, the autonomous vehicle has a problem that the driver on board or the passenger resolves the glare by themselves as the glare state is not recognized by the driver on board or the passenger.

### SUMMARY OF THE INVENTION

An object of the present disclosure is to solve the above-mentioned needs and/or problems.

In addition, an object of the present disclosure is to implement a control method of an autonomous vehicle capable of blocking driving disturbance of a driver by an external light source (sunlight, vehicle headlights at night in an opposite side, etc.) of the autonomous vehicle.

A method of controlling of an autonomous vehicle according to an embodiment of the present disclosure, the method comprising the steps of: acquiring state information of a driver from a sensor mounted inside the vehicle; determining a glare state of the driver based on state information of the driver; operating a primary light source blocking when recognizing a glare state of the driver; operating, by the primary light source blocking, a light source blocking device mounted on the vehicle at the moment of recognizing the glare state of the driver, and tracking a gaze direction of the driver through a first image to acquire the gaze direction of the driver; and operating secondary light source blocking, when the acquired gaze direction of the driver is outside a predetermined range.

In addition, the state information of the driver may include at least one of the numbers of eyelid closure of the driver, an open size of the eyelid, facial expression of the driver, the gaze direction of the driver acquired by analyzing the first image.

In addition, the step of determining the glare state of the driver may comprise the steps of: extracting feature values from sensing information acquired through at least one sensor; and inputting the feature values to an artificial neural network (ANN) classifier trained to distinguish whether the driver is in a normal state or a glare state, and determining the glare state of the driver from an output of the artificial neural network, wherein the feature values may be values to distinguish from the normal state and the glare state of the driver.

In addition, the method may further comprise the steps of: acquiring a second image from a second camera mounted inside the vehicle; acquiring state information of a passenger in the vehicle through the second image and determining a glare state of the passenger based on the state information of the passenger; operating a primary light source blocking when a glare state of the passenger is recognized; and operating, by the primary light source blocking, a light source blocking device mounted on the vehicle at the moment of recognizing the glare state of the passenger.

In addition, the light source blocking device includes one of a sun visor, curtain, a sun shade.

In addition, the step of operating the primary light source blocking may comprise the steps of applying a primary filtering to the light source coming through a windshield of the vehicle using the sun visor positioned between the windshield of the vehicle and the driver, and applying a secondary filtering to the light source, when the gaze direction of the driver is out of the predetermined range.

In addition, the sun visor may comprise displaying driving information related to the traveling direction of the vehicle on a partial area displayed.

In addition, the driving information may include traffic lights, other vehicles, and pedestrians.

In addition, the method may further comprise the step of transmitting a V2X message including information related to the glare state of the driver to another terminal connected in communication with the vehicle.

In addition, the method may further comprise the step of receiving downlink control information (DCI) from a network, which is used to schedule transmission of the state information of driver obtained from at least one sensor provided in the vehicle, wherein the state information of the driver may be transmitted to the network based on the DCI.

In addition, the method may further comprise the step of performing an initial access procedure with the network based on a synchronization signal block (SSB), wherein the state information of the driver may be transmitted to the network through a PUSCH, and a DM-RS of the PUSCH of the SSB may be quasi-co-located (QCLed) for a QCL type D.

In addition, the method may further comprise the steps of controlling a communication unit to transmit the state information of the driver to an AI processor included in the network; and controlling the communication unit to receive the AI processed information from the AI processor, wherein the AI processed information may be information in which the state of the driver is determined as either a glare state or a normal state.

In the control method of the autonomous vehicle according to an embodiment of the present disclosure, when the inconvenience of the driver or the passenger is recognized by an external light source, a device such as a sun visor, a curtain, and a sunshade for blocking the light source may be operated, thereby solving the inconvenience.

In addition, the present disclosure can improve the safety of the autonomous vehicle by displaying the main information (traffic light, vehicle, pedestrian, etc.) in the obscured area on the sun visor in order to prevent the problem of the field of vision is obscured when using the sun visor, thereby increasing the safety of the autonomous vehicle.

In addition, the present disclosure can reduce the fatigue on the eyes of the driver by predicting and appropriately blocking the glare of the driver by sunlight, which is an external light source.

### BRIEF DESCRIPTION OF THE DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an user equipment and a 5G network in a 5G communication system

FIG. 4 is a diagram showing a vehicle according to an embodiment of the present disclosure.

FIG. 5 is a block diagram of an AI device according to an embodiment of the present disclosure.

FIG. 6 is a diagram for illustrating a system in which an autonomous vehicle and an AI device according to an embodiment of the present disclosure are linked.

FIG. 7 is a flowchart illustrating a vehicle control method according to an embodiment of the present disclosure.

FIG. 8 is a diagram for describing an example of determining the glare state in an embodiment of the present disclosure.

FIG. 9 is a diagram for describing another example of determining the glare state in an embodiment of the present disclosure.

FIG. 10 is a flowchart illustrating a light source blocking method of a vehicle in a glare state of a driver according to an embodiment of the present disclosure.

FIGS.11 to 14 is diagrams for describing the example illustrated in FIG. 10.

FIG. 15 is a flowchart illustrating a method of controlling a light source blocking device in a glare state of a passenger according to an embodiment of the present disclosure.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

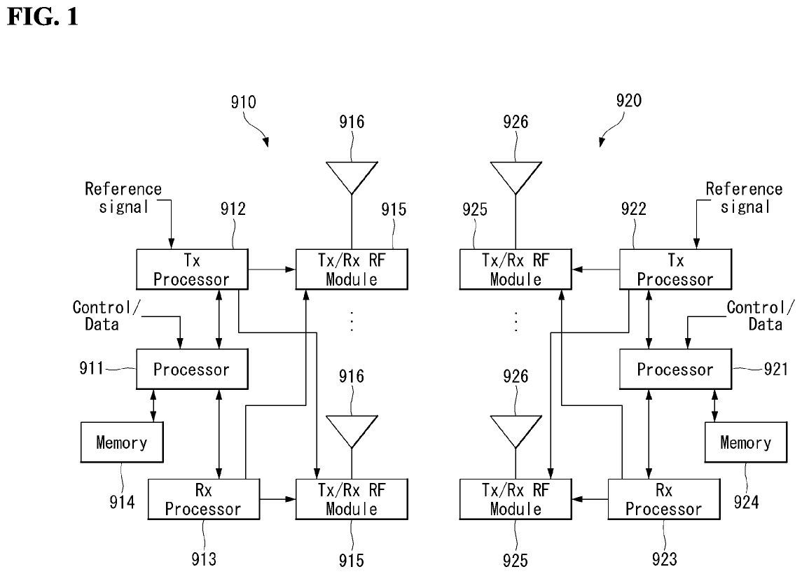

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

According to an embodiment of the present disclosure, the first communication device may be a vehicle, and the second communication device may be a 5G network.

B. Signal Transmission/Reception Method in Wireless Communication System

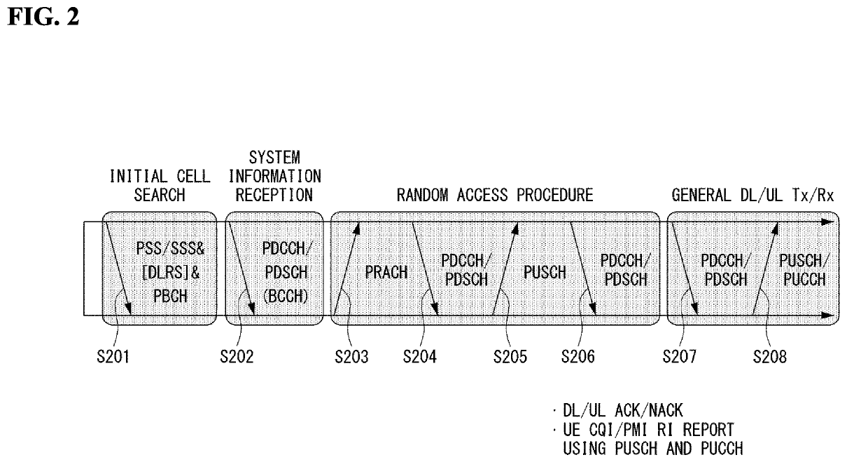

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLE BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles using 5G Communication

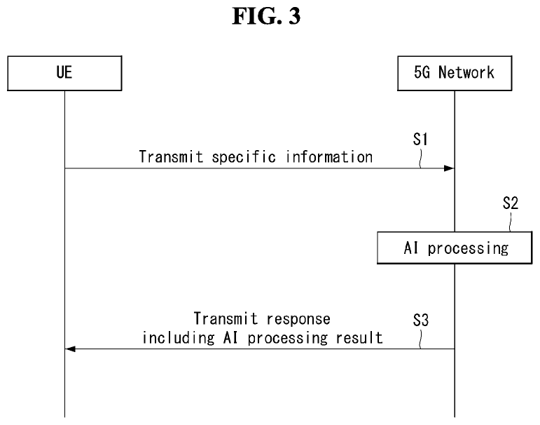

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present disclosure which will be described later and applied or can complement the methods proposed in the present disclosure to make technical features of the methods concrete and clear.

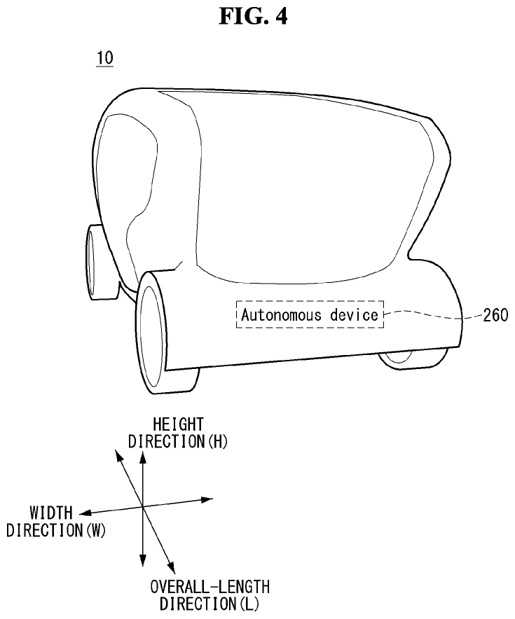

FIG. 4 is a diagram showing a vehicle according to an embodiment of the present disclosure.

Referring to FIG. 4, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

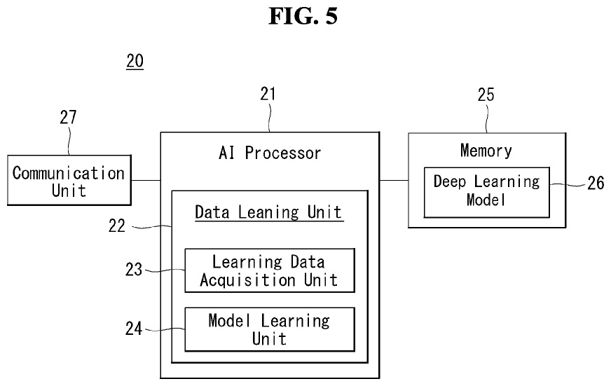

FIG. 5 is a block diagram of an AI device according to an embodiment of the present disclosure.

An AI device 20 may include an electronic device including an AI module that can perform AI processing, a server including the AI module, or the like. Further, the AI device 20 may be included as at least one component of the vehicle 10 shown in FIG. 1 to perform together at least a portion of the AI processing.

The AI processing may include all operations related to driving of the vehicle 10 shown in FIG. 4. For example, an autonomous vehicle can perform operations of processing/determining, and control signal generating by performing AI processing on sensing data or driver data. Further, for example, an autonomous vehicle can perform autonomous driving control by performing AI processing on data acquired through interaction with other electronic devices included in the vehicle.

The AI device 20 may include an AI processor 21, a memory 25, and/or a communication unit 27.

The AI device 20, which is a computing device that can learn a neural network, may be implemented as various electronic devices such as a server, a desktop PC, a notebook PC, and a tablet PC.

The AI processor 21 can learn a neural network using programs stored in the memory 25. In particular, the AI processor 21 can learn a neural network for recognizing data related to vehicles. Here, the neural network for recognizing data related to vehicles may be designed to simulate the brain structure of human on a computer and may include a plurality of network nodes having weights and simulating the neurons of human neural network. The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks(CNN), recurrent neural networks (RNN), a restricted boltzmann machine (RBM), deep belief networks (DBN), and a deep Q-network, and can be applied to fields such as computer vision, voice recognition, natural language processing, and voice/signal processing.

Meanwhile, a processor that performs the functions described above may be a general purpose processor (e.g., a CPU), but may be an AI-only processor (e.g., a GPU) for artificial intelligence learning.

The memory 25 can store various programs and data for the operation of the AI device 20. The memory 25 may be a nonvolatile memory, a volatile memory, a flash-memory, a hard disk drive (HDD), a solid state drive (SDD), or the like. The memory 25 is accessed by the AI processor 21 and reading-out/recording/correcting/deleting/updating, etc. of data by the AI processor 21 can be performed. Further, the memory 25 can store a neural network model (e.g., a deep learning model 26) generated through a learning algorithm for data classification/recognition according to an embodiment of the present disclosure.

Meanwhile, the AI processor 21 may include a data learning unit 22 that learns a neural network for data classification/recognition. The data learning unit 22 can learn references about what learning data are used and how to classify and recognize data using the learning data in order to determine data classification/recognition. The data learning unit 22 can learn a deep learning model by acquiring learning data to be used for learning and by applying the acquired learning data to the deep learning model.

The data learning unit 22 may be manufactured in the type of at least one hardware chip and mounted on the AI device 20. For example, the data learning unit 22 may be manufactured in a hardware chip type only for artificial intelligence, and may be manufactured as a part of a general purpose processor (CPU) or a graphics processing unit (GPU) and mounted on the AI device 20. Further, the data learning unit 22 may be implemented as a software module. When the data leaning unit 22 is implemented as a software module (or a program module including instructions), the software module may be stored in non-transitory computer readable media that can be read through a computer. In this case, at least one software module may be provided by an OS (operating system) or may be provided by an application.

The data learning unit 22 may include a learning data acquiring unit 23 and a model learning unit 24.

The learning data acquiring unit 23 can acquire learning data required for a neural network model for classifying and recognizing data. For example, the learning data acquiring unit 23 can acquire, as learning data, vehicle data and/or sample data to be input to a neural network model.

The model learning unit 24 can perform learning such that a neural network model has a determination reference about how to classify predetermined data, using the acquired learning data. In this case, the model learning unit 24 can train a neural network model through supervised learning that uses at least some of learning data as a determination reference. Alternatively, the model learning data 24 can train a neural network model through unsupervised learning that finds out a determination reference by performing learning by itself using learning data without supervision. Further, the model learning unit 24 can train a neural network model through reinforcement learning using feedback about whether the result of situation determination according to learning is correct. Further, the model learning unit 24 can train a neural network model using a learning algorithm including error back-propagation or gradient decent.

When a neural network model is learned, the model learning unit 24 can store the learned neural network model in the memory. The model learning unit 24 may store the learned neural network model in the memory of a server connected with the AI device 20 through a wire or wireless network.

The data learning unit 22 may further include a learning data preprocessor (not shown) and a learning data selector (not shown) to improve the analysis result of a recognition model or reduce resources or time for generating a recognition model.

The learning data preprocessor can preprocess acquired data such that the acquired data can be used in learning for situation determination. For example, the learning data preprocessor can process acquired data in a predetermined format such that the model learning unit 24 can use learning data acquired for learning for image recognition.

Further, the learning data selector can select data for learning from the learning data acquired by the learning data acquiring unit 23 or the learning data preprocessed by the preprocessor. The selected learning data can be provided to the model learning unit 24. For example, the learning data selector can select only data for objects included in a specific area as learning data by detecting the specific area in an image acquired through a camera of a vehicle.

Further, the data learning unit 22 may further include a model estimator (not shown) to improve the analysis result of a neural network model.

The model estimator inputs estimation data to a neural network model, and when an analysis result output from the estimation data does not satisfy a predetermined reference, it can make the model learning unit 22 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 27 can transmit the AI processing result by the AI processor 21 to an external electronic device.

Here, the external electronic device may be defined as an autonomous vehicle. Further, the AI device 20 may be defined as another vehicle or a 5G network that communicates with the autonomous vehicle. Meanwhile, the AI device 20 may be implemented by being functionally embedded in an autonomous module included in a vehicle. Further, the 5G network may include a server or a module that performs control related to autonomous driving.

Meanwhile, the AI device 20 shown in FIG. 5 was functionally separately described into the AI processor 21, the memory 25, the communication unit 27, etc., but it should be noted that the aforementioned components may be integrated in one module and referred to as an AI module.

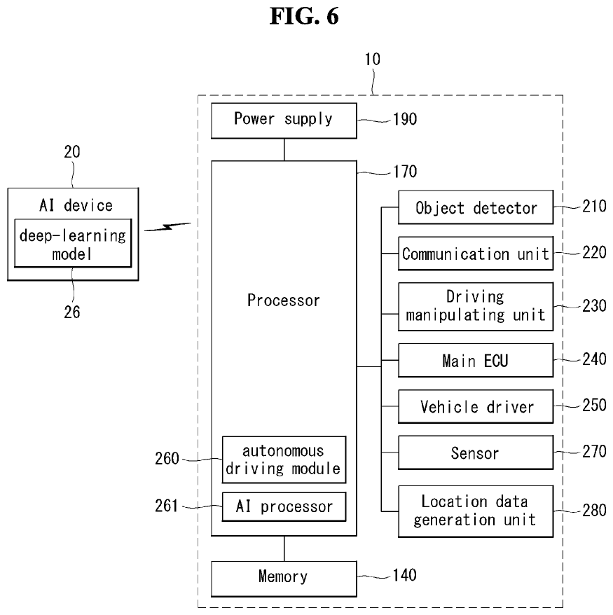

FIG. 6 is a diagram for illustrating a system in which an autonomous vehicle and an AI device according to an embodiment of the present disclosure are linked.

Referring to FIG. 6, an autonomous vehicle 10 can transmit data that require AI processing to an AI device 20 through a communication unit and the AI device 20 including a neural network model 26 can transmit an AI processing result using the neural network model 26 to the autonomous vehicle 10. The description of FIG. 2 can be referred to for the AI device 20.

The autonomous vehicle 10 may include a memory 140, a processor 170, and a power supply 170 and the processor 170 may further include an autonomous module 260 and an AI processor 261. Further, the autonomous vehicle 10 may include an interface that is connected with at least one electronic device included in the vehicle in a wired or wireless manner and can exchange data for autonomous driving control. At least one electronic device connected through the interface may include an object detection unit 210, a communication unit 220, a driving operation unit 230, a main ECU 240, a vehicle driving unit 250, a sensing unit 270, and a position data generation unit 280.

The interface can be configured using at least one of a communication module, a terminal, a pin, a cable, a port, a circuit, an element, and a device.

The memory 140 is electrically connected with the processor 170. The memory 140 can store basic data about units, control data for operation control of units, and input/output data. The memory 140 can store data processed in the processor 170. Hardware-wise, the memory 140 may be configured using at least one of a ROM, a RAM, an EPROM, a flash drive and a hard drive. The memory 140 can store various types of data for the overall operation of the autonomous vehicle 10, such as a program for processing or control of the processor 170. The memory 140 may be integrated with the processor 170. Depending on embodiments, the memory 140 may be classified as a lower configuration of the processor 170.

The power supply 190 can supply power to the autonomous vehicle 10. The power supply 190 can be provided with power from a power source (e.g., a battery) included in the autonomous vehicle 10 and can supply the power to each unit of the autonomous vehicle 10. The power supply 190 can operate according to a control signal supplied from the main ECU 240. The power supply 190 may include a switched-mode power supply (SMPS).

The processor 170 can be electrically connected to the memory 140, the interface 180, and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal, and provide the signal while power is supplied thereto by the power supply 190.

The processor 170 can receive information from other electronic devices included in the autonomous vehicle 10 through the interface. The processor 170 can provide control signals to other electronic devices in the autonomous vehicle 10 through the interface.

The autonomous device 10 may include at least one printed circuit board (PCB). The memory 140, the interface, the power supply 190, and the processor 170 may be electrically connected to the PCB.

Hereafter, other electronic devices connected with the interface and included in the vehicle, the AI processor 261, and the autonomous module 260 will be described in more detail. Hereafter, for the convenience of description, the autonomous vehicle 10 is referred to as a vehicle 10.

First, the object detection unit 210 can generate information on objects outside the vehicle 10. The AI processor 261 can generate at least one of on presence or absence of an object, positional information of the object, information on a distance between the vehicle and the object, and information on a relative speed of the vehicle with respect to the object by applying data acquired through the object detection unit 210 to a neural network model.

The object detection unit 210 may include at least one sensor that can detect objects outside the vehicle 10. The sensor may include at least one of a camera, a radar, a lidar, an ultrasonic sensor, and an infrared sensor. The object detection unit 210 can provide data about an object generated on the basis of a sensing signal generated from a sensor to at least one electronic device included in the vehicle.

Meanwhile, the vehicle 10 transmits the sensing data acquired through at least one sensor to the AI device 20 through the communication unit 220 and the AI device 20 can transmit AI processing data by applying the neural network model 26 to the transmitted data to the vehicle 10. The vehicle 10 recognizes information about the detected object on the basis of the received AI processing data and the autonomous module 260 can perform an autonomous driving control operation using the recognized information.

The communication unit 220 can exchange signals with devices disposed outside the vehicle 10. The communication unit 220 can exchange signals with at least any one of an infrastructure (e.g., a server and a broadcast station), another vehicle, and a terminal. The communication unit 220 may include at least any one of a transmission antenna, a reception antenna, a radio frequency (RF) circuit which can implement various communication protocols, and an RF element in order to perform communication.

It is possible to generate at least one of on presence or absence of an object, positional information of the object, information on a distance between the vehicle and the object, and information on a relative speed of the vehicle with respect to the object by applying data acquired through the object detection unit 210 to a neural network model.

The driving operation unit 230 is a device for receiving user input for driving. In a manual mode, the vehicle 10 may be driven on the basis of a signal provided by the driving operation unit 230. The driving operation unit 230 may include a steering input device (e.g., a steering wheel), an acceleration input device (e.g., an accelerator pedal), and a brake input device (e.g., a brake pedal).

Meanwhile, the AI processor 261, in an autonomous mode, can generate an input signal of the driving operation unit 230 in accordance with a signal for controlling movement of the vehicle according to a driving plan generated through the autonomous module 260.

Meanwhile, the vehicle 10 transmits data for control of the driving operation unit 230 to the AI device 20 through the communication unit 220 and the AI device 20 can transmit AI processing data generated by applying the neural network model 26 to the transmitted data to the vehicle 10. The vehicle 10 can use the input signal of the driving operation unit 230 to control movement of the vehicle on the basis of the received AI processing data.

The main ECU 240 can control the overall operation of at least one electronic device included in the vehicle 10.

The vehicle driving unit 250 is a device for electrically controlling various vehicle driving devices included in the vehicle 10. The vehicle driving unit 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device, and a suspension driving control device. Meanwhile, the safety device driving control device may include a seatbelt driving control device for seatbelt control.

The vehicle driving unit 250 includes at least one electronic control device (e.g., a control ECU (Electronic Control Unit)).

The vehicle driving unit 250 can control a power train, a steering device, and a brake device on the basis of signals received by the autonomous module 260. The signals received by the autonomous module 260 may be driving control signals that are generated by applying a neural network model to data related to the vehicle in the AI processor 261. The driving control signals may be signals received from the external AI device 20 through the communication unit 220.

The sensing unit 270 can sense a state of the vehicle. The sensing unit 270 may include at least any one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor, and a magnetic sensor.

The AI processor 261 can generate state data of the vehicle by applying a neural network model to sensing data generated by at least one sensor. The AI processing data generated by applying the neural network model may include vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an accelerator pedal, data of a pressure applied to a brake pedal, etc.

The autonomous module 260 can generate a driving control signal on the basis of the AI-processed state data of the vehicle.

Meanwhile, the vehicle 10 transmits the sensing data acquired through at least one sensor to the AI device 20 through the communication unit 22 and the AI device 20 can transmit AI processing data generated by applying the neural network model 26 to the transmitted data to the vehicle 10.

The position data generation unit 280 can generate position data of the vehicle 10. The position data generation unit 280 may include at least any one of a global positioning system (GPS) and a differential global positioning system (DGPS).

The AI processor 261 can generate more accurate position data of the vehicle by applying a neural network model to position data generated by at least one position data generation device.

In accordance with an embodiment, the AI processor 261 can perform deep learning calculation on the basis of at least any one of the internal measurement unit (IMU) of the sensing unit 270 and the camera image of the object detection unit 210 and can correct position data on the basis of the generated AI processing data.

Meanwhile, the vehicle 10 transmits the position data acquired from the position data generation unit 280 to the AI device 20 through the communication unit 220 and the AI device 20 can transmit the AI processing data generated by applying the neural network model 26 to the received position data to the vehicle 10.

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

The autonomous module 260 can generate a route for autonomous driving and a driving plan for driving along the generated route on the basis of the acquired data.

The autonomous module 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring), and TJA (Traffic Jam Assist).

The AI processor 261 can transmit control signals that can perform at least one of the ADAS functions described above to the autonomous module 260 by applying traffic-related information received from at least one sensor included in the vehicle and external devices and information received from another vehicle communicating with the vehicle to a neural network model.

Further, the vehicle 10 transmits at least one data for performing the ADAS functions to the AI device 20 through the communication unit 220 and the AI device 20 can transmit the control signal that can perform the ADAS functions to the vehicle 10 by applying the neural network model 260 to the received data.

The autonomous module 260 can acquire state information of a driver and/or state information of a vehicle through the AI processor 261 and can perform switching from an autonomous mode to a manual driving mode or switching from the manual driving mode to the autonomous mode.

Meanwhile, the vehicle 10 can use AI processing data for passenger support for driving control. For example, as described above, it is possible to check the states of a driver and passengers through at least one sensor included in the vehicle.

Alternatively, the vehicle 10 can recognize voice signals of a driver or passengers, perform a voice processing operation, and perform a voice synthesis operation through the AI processor 261.

5G communication for implementing the vehicle control method according to an embodiment of the present disclosure and schematic contents for performing AI processing by applying the 5G communication and for transmitting/receiving the AI processing result were described above.

Hereafter, a detailed method of passively intervening or actively intervening in a careless state of a driver on the basis of state information of the driver in accordance with an embodiment of the present disclosure is described with reference to necessary drawings.

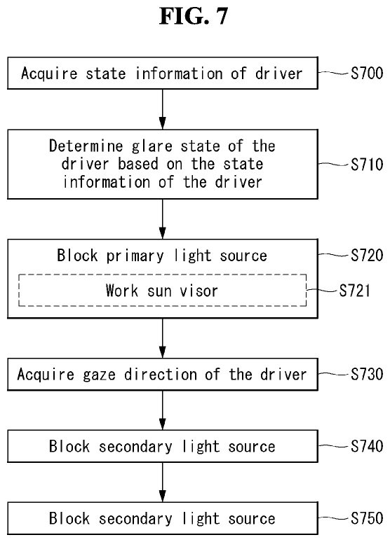

FIG. 7 is a flowchart illustrating a vehicle control method according to an embodiment of the present disclosure.

The vehicle control method according to an embodiment of the present disclosure may be implemented in a vehicle including the function described with reference to FIGS. 1 to 5 or an intelligent device for controlling the vehicle. More specifically, the vehicle control method according to an embodiment of the present disclosure may be implemented in the vehicle 10 described with reference to FIGS. 4 and 6.

The processor 170 may detect an external light source using an external camera of the vehicle. The processor 170 of FIG. 5 may acquire state information of the driver (S700).

The processor 170 may acquire state information of the driver through at least one sensor provided in the vehicle.

The at least one sensor may be at least one camera provided in the vehicle 10. For example, the first camera may be arranged to capture the driver from the front direction and the left and right directions. The processor 170 may analyze the first image acquired from the first camera to determine the glare state of the driver.

The state information of the driver may include at least one of the numbers of eyelid closure of the driver, an open size of the eyelid, facial expression of the driver, the gaze direction of the driver acquired by analyzing the first image, and it may be used to determine a glare state of the driver by analyzing the state information. For example, the movement speed of the eyelid may be determined as a glare state when the speed of blinking the eye exceeds a predetermined reference value or more. In addition, for example, the eye blinking depth may be measured, and the glare state may be determined based on the eye blinking depth when the eyes are awake. That is, the processor 170 may display an image acquired through the camera based on the numbers of eyelid closure of the driver, an open size of the eyelid, facial expression of the driver, the gaze direction of the driver as a reference value, when the driver is in a normal state without glare. By analyzing, the analysis result may be transmitted to the processor 170.

The processor 170 may determine the glare state of the driver based on the state information of the driver (S710).

A detailed process of determining the glare state will be described later with reference to FIG. 7. As described above, the determination of the glare state of the driver based on the state information of the driver may be performed in the vehicle 10, itself or in a 5G network.

When the processor 170 recognizes the glare state of the driver, the processor 170 may operate to block the primary light source (S720).

The primary light source blocking may operate at least one of a sun visor, a curtain, and a sunshade installed in the vehicle. The primary light source blocking may include an operation of working the sun visor (S721).

The sun visor mounted on the vehicle may be disposed between the windshield of the vehicle and the driver. The sun visor may be mounted on the top of the driver's seat as either a ceiling mount (operated as sliding) or external attachment. The sun visor may comprise a transparent display. For example, the sun visor mounted on the vehicle may use a method of providing optical see-through information. The optical see-through method is a method in which a user sees the external world with the naked eye through a transparent display and simultaneously overlaps virtual objects displayed on the transparent display. The optical see-through method applicable to the vehicle may be broadly classified into a display panel method, a laser method, and a projection method according to an implementation method. Descriptions of various implementations of the optical see-through method are well known and will be omitted.

On the other hand, the virtual object displayed on the transparent display may be an image projected in the traveling direction of the vehicle 10 so as not to interfere with driving by a driver. For example, the virtual object may display driving information such as a traffic light and a traffic sign. In other words, the present disclosure may display main information (traffic light, vehicle, pedestrian, etc.) in the obscured area in the driver's seat in order to prevent the problem of the field of view when using the sun visor. The sun visor capable of displaying the driving information may be used as a driving information display mode by only partially lowering it even in the normal times.

The processor 170 may track the gaze of the driver through the camera inside the vehicle to acquire the gaze direction of the driver (S730).

The processor 170 may extract feature points (eyes, eyebrows, lips, glasses, sunglasses, etc.) from the face image of the driver captured through the camera. The processor 170 may detect the location of the feature point on the face coordinate system (x, y, z) generated based on the face center point. In this case, the face coordinate system may be generated based on an arbitrary point in the image rather than the face center point. The processor 170 may calculate the amount of movement of the face and the amount of rotation of the face in units of predetermined time based on a change in the position of the feature point on the face coordinate system according to the movement of the driver's face. The amount of movement of the face may mean a distance of movement of the face generated by the movement of the body, and the amount of rotation of the face may mean a direction vector representing a biaxial rotation angle (Roll, Pitch Yaw). The processor 170 may store the position and direction vector of the driver's face in real time, and a method of detecting the direction vector of the face may be implemented in various manner

In addition, the processor 170 may check whether the acquired gaze direction of the driver is within a predetermined range (S740). The predetermined range may be set to both sides of the windshield of the vehicle. The processor 170 may determine the gaze direction of the driver based on a time at which the driver views the left or right side mirror away from both sides of the windshield of the vehicle. For example, the processor 170 may determine that the gaze direction of the driver is within the predetermined range when the gaze direction of the driver is viewed to look shorter than the predetermined range of the left or right side and away from both sides of the windshield of the vehicle. Alternatively, the processor 170 may determine that the gaze direction of the driver is out of the predetermined range when the gaze direction of the driver is beyond the predetermined range when the gaze direction of the driver is viewed to look longer than the predetermined range of the left or right side and away from both sides of the windshield of the vehicle.

When determining that the gaze direction of the driver is out of a predetermined range, the processor 170 may operate to block the second light source (S750). Thereafter, the processor 170 may control the light source blocking device in the vehicle to block the secondary light source. The light source blocking device may be at least one of a sun visor, a curtain, and a sunshade mounted inside the vehicle.

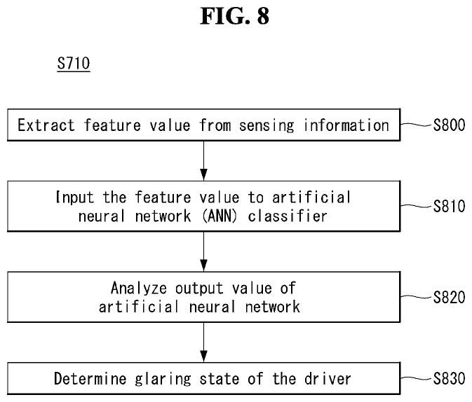

FIG. 8 is a diagram for describing an example of determining the glare state in an embodiment of the present disclosure.

Referring to FIG. 8, the processor 170 may extract feature values from sensing information acquired through at least one sensor in order to determine the glare state of the driver (S800).

For example, the processor 170 may receive state information of the driver from at least one sensor (e.g., a camera). The processor 170 may extract a feature value from the state information of the driver. The feature value is determined to specifically indicate the transition from the normal state to the glare state of the driver among at least one feature that can be extracted from the driver's state.

The processor 170 may control the feature values to be input to an artificial neural network (ANN) classifier trained to distinguish whether the driver is in a normal state or a glare state (S810).

The processor 170 may combine the extracted feature values to generate a glare detection input. The glare detection input may be input to an artificial neural network (ANN) classifier trained to allow the driver to distinguish between a normal state and a glare state based on the extracted feature value.

The processor 170 may analyze an output value of the artificial neural network (S820) and determine a glaring state of the driver based on the artificial neural network output value (S830).

The processor 170 may identify from the output of the artificial neural network classifier whether the driver starts glaring or is in a glare state.

Meanwhile, although FIG. 8 illustrates an example in which the operation of identifying the glare state of the driver through AI processing is implemented in the processing of the vehicle 10, the present disclosure is not limited thereto. For example, the AI processing may be performed on a 5G network based on sensing information received from the vehicle 10.

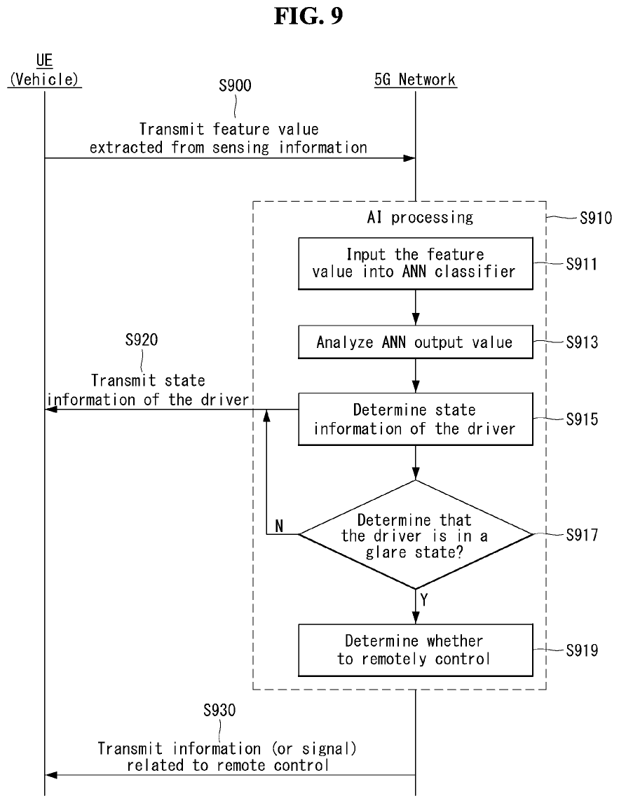

FIG. 9 is a diagram for describing another example of determining the glare state in an embodiment of the present disclosure.

The processor 170 may control a communication unit to transmit the state information of the driver to the AI processor included in the 5G network. In addition, the processor 170 may control the communication unit to receive AI processed information from the AI processor.

The AI processed information may be information on which the state of the driver is determined as either a normal state or a glare state.

Meanwhile, the vehicle 10 may perform an initial access procedure with the 5G network in order to transmit the state information of the driver to the 5G network. The vehicle 10 may perform an initial access procedure with the 5G network based on a synchronization signal block (SSB).

In addition, the vehicle 10 may receive from the network downlink control information (DCI) used to schedule transmission of the state information of the driver acquired from at least one sensor provided in the vehicle through a wireless communication unit.

The processor 170 may transmit the state information of the driver to the network based on the DCI.

The state information of the driver is transmitted to the network through a PUSCH, and the DM-RS of the PUSCH and the SSB may be quasi-co-located (QCLed) for QCL type D.

Referring to FIG. 9, the vehicle 10 may transmit a feature value extracted from sensing information to a 5G network (S900).

Here, the 5G network may include an AI processor or an AI system, and the AI system of the 5G network may perform AI processing based on the received sensing information (S910).

The AI system may input feature values received from the vehicle 10 into the ANN classifier (S911). The AI system may analyze the ANN output value (S913) and determine the state of the driver from the ANN output value (S915). The 5G network may transmit the state information of the driver determined by the AI system to the vehicle 10 through the wireless communication unit.

Here, the state information of the driver may include whether the driver is in a normal state, a glare state, a state of starting to switch from the normal state to the glare state, and the like.

When the AI system determines that the driver is in a glare state (or starts to switch from the normal state to the glare state) (S917), the driver is controlled to be out of the glare state by operating a light source blocking device mounted on the vehicle.

When the driver is in a glare state, the AI system may determine whether to remotely control the light source blocking device (S919). In addition, the AI system may transmit information (or signals) related to the remote control to the vehicle 10.

Meanwhile, the vehicle 10 may transmit only the sensing information to the 5G network, and is used for the glare detection and may extract a feature value corresponding to the glare detection input to be used as an input of an artificial neural network for determining the glare state of the driver from the sensing information in the AI system included in the 5G network.

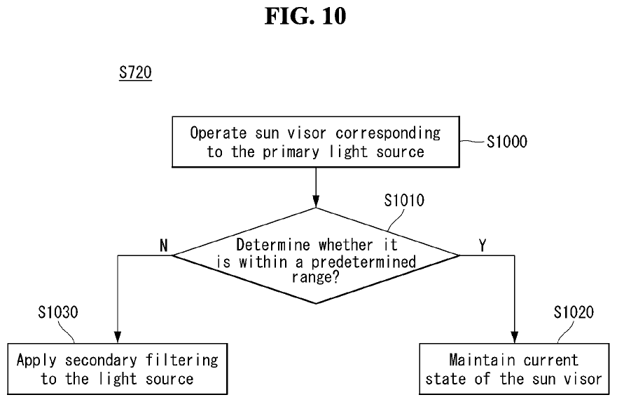

FIG. 10 is a flowchart illustrating a light source blocking method of a vehicle in a glare state of a driver according to an embodiment of the present disclosure.

Referring to FIG. 10, when it is determined that the driver is in a glare state, the processor 170 may block the primary light source and operate the light source blocking device corresponding to the primary light source (S1000).

As described above, the primary light source blocking is intended to allow the driver to be out of the glare state, by operating the light source blocking device mounted on the vehicle at the moment of recognizing the glare state of the driving driver.

The primary light source blocking operation may apply a first filtering to the amount of light entering through the windshield of the vehicle by using the sun visor positioned between the windshield of the vehicle and the driver.

The processor 170 may apply a first filtering to the amount of light and then track the gaze direction of the driver, and determine whether the tracked gaze direction of the driver is out of a predetermined range (S1010).

When the processor 170 recognizes that the tracked gaze direction of the driver is within a predetermined range, the processor 170 may continuously maintain the current state of the sun visor that primarily filtered the light source (S1020). For example, when the gaze direction of the driver is facing the windshield of the vehicle overlapping with the sun visor, the processor 170 may determine that the state of the driver is switched from the glare state to the normal state by the primarily filtered sun visor.

When the processor 170 recognizes that the gaze direction of the driver is out of a predetermined range, the processor 170 may apply a secondary filtering to the light source (S1030). For example, when the processor 170 recognizes that the gaze direction of the driver is out of a predetermined range, the processor 170 may determine that the glare state of the driver is continued and may apply a secondary filtering to the sun visor.

The secondarily filtered sun visor may overlap the windshield of the vehicle with a larger area than the primarily filtered sun visor. For example, the sun visor apply may a first filtering by overlapping the windshield of the vehicle with a first area. The sun visor may apply a secondary filtering by overlapping the windshield of the vehicle with a second area that is wider than the first area.

Alternatively, the secondarily filtered sun visor may lower the visible light transmittance than the primarily filtered sun visor. For example, the primarily filtered sun visor may have a visible light transmittance of 70% or more. The secondarily filtered sun visor may have a visible light transmittance of 70% or less.

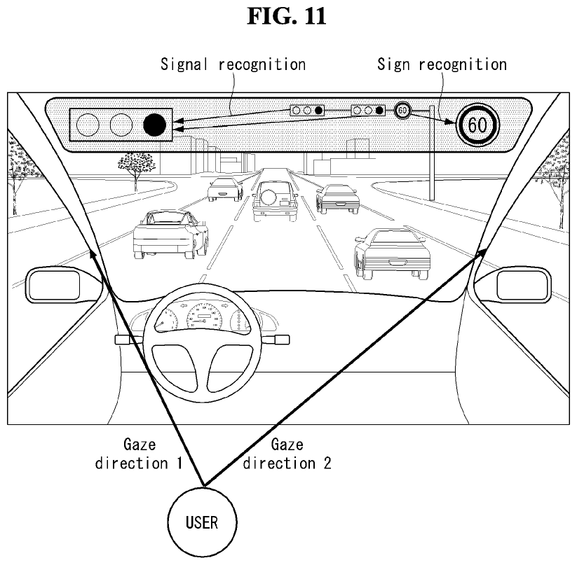

FIGS. 11 to 14 is diagrams for describing the example illustrated in FIG. 10.

Referring to FIG. 11, the processor 170 may operate the sun visor at the moment of recognizing the glare state of the driver, and may control the first area of the sun visor to overlap the windshield of the vehicle.

The processor 170 tracks the gaze direction of the driver acquired through the camera 220 to estimate whether the gaze direction of the driver is between a first direction (Gaze direction 1) and a second direction (Gaze direction 2), which are predetermined ranges.

In addition, the processor 170 may receive a DL grant from the 5G network to receive an AI processing result including whether the driver is in a glare state from the 5G network. The processor 170 may receive an AI processing result on whether the driver is in a glare state based on the DL grant. The processor 170 may recognize whether the gaze direction of the driver is within a predetermined range at the time of receiving the DL grant from the 5G network.

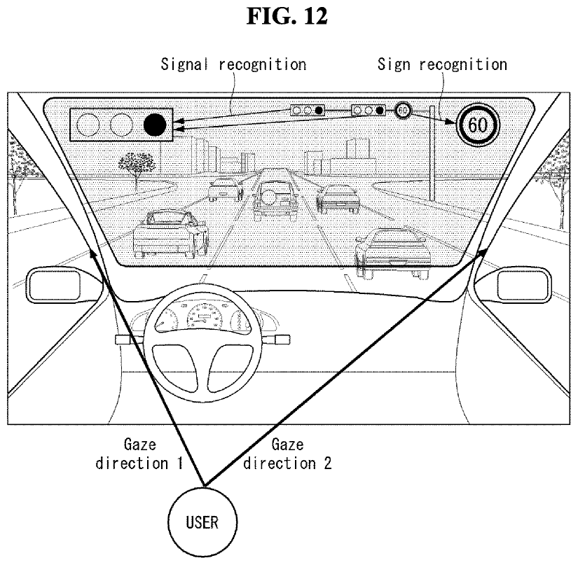

Referring to FIG. 12, when the processor 170 apply a first filtering to the light source and then continues to recognize the glare state of the driver, the processor 170 may operate the sun visor and control the second area of the sun visor to overlap the windshield of the vehicle. The second area of the sun visor may be an area wider than the first area of the sun visor.

The processor 170 tracks the gaze direction of the driver acquired through the camera 220, to estimate whether the gaze direction of the driver is out of between the first direction (Gaze direction 1) and the second direction (Gaze direction 2), which are predetermined ranges.

In addition, the processor 170 may receive a DL grant from the 5G network to receive an AI processing result including whether the driver is in a glare state from the 5G network. The processor 170 may receive an AI processing result on whether the driver is in a glare state based on the DL grant. The processor 170 may recognize whether the gaze direction of the driver is out of a predetermined range at the time of receiving the DL grant from the 5G network.

In addition, the processor 170 may output feedback about the gaze direction of the driver captured by the camera. The feedback may output current state information of the driver based on a result of sensing the gaze direction of the driver, the facial expression of the driver, whether the driver wears sunglasses, the hand gesture of the driver, and the like.

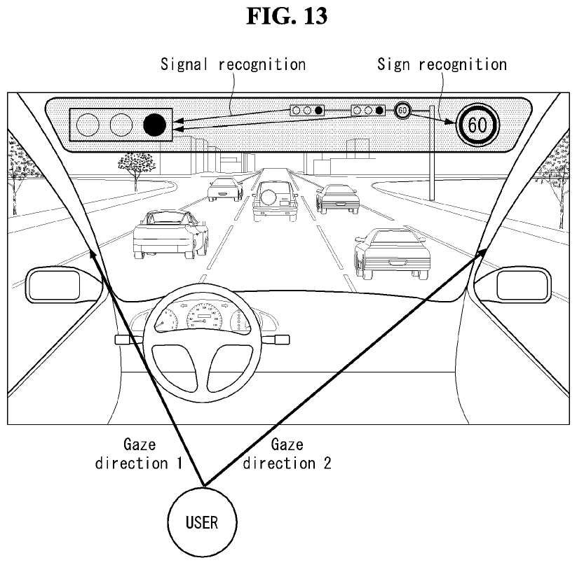

Referring to FIG. 13, the processor 170 may operate the sun visor at the moment of recognizing the glare of the driver, and may adjust the visible light transmittance of the sun visor to 70% or more.

The processor 170 tracks the gaze direction of the driver acquired through the camera 220 to estimate whether the gaze direction of the driver is between a first direction (Gaze direction 1) and a second direction (Gaze direction 2), which are predetermined ranges.

The processor 170 may maintain the visible light transmittance of the sun visor substantially at 70% when it is determined that the estimated driver's gaze direction is within the first direction (Gaze direction 1) and the second direction (Gaze direction 2).

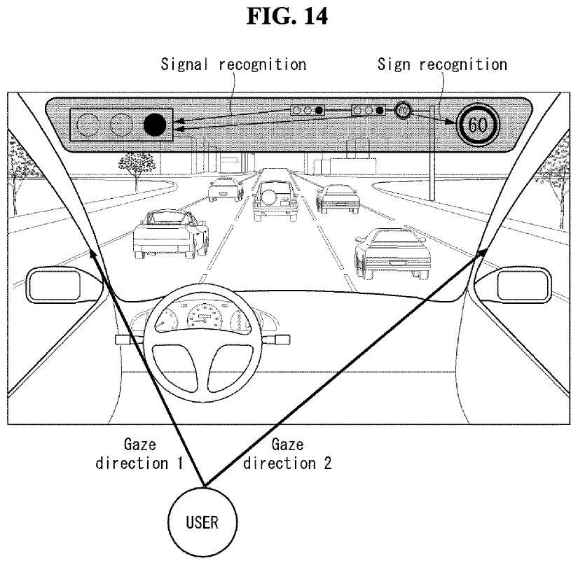

Referring to FIG. 14, when the processor 170 apply a first filtering to the light source and then continues to recognize the glare state of the driver, the processor 170 may operate the sun visor and may adjust the visible light transmittance of the sun visor to 70% or less.

The processor 170 tracks the gaze direction of the driver acquired through the camera 220 to estimate whether the gaze direction of the driver is out of between the first direction (Gaze direction 1) and the second direction (Gaze direction 2), which are predetermined ranges.

When it is determined that the estimated gaze direction of the driver is out of between the first direction (Gaze direction 1) and the second direction (Gaze direction 2), the processor 170 may lower the visible light transmittance of the sun visor to 70% or less.

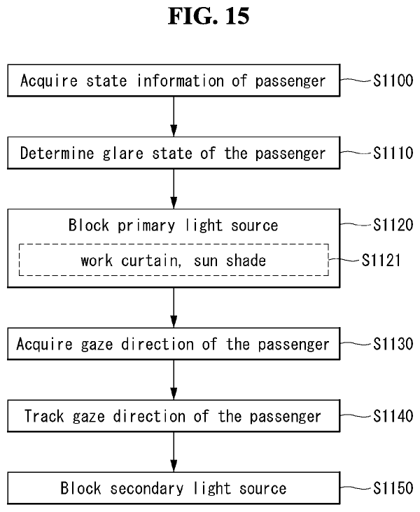

FIG. 15 is a flowchart illustrating a method of controlling a light source blocking device in a glare state of a passenger according to an embodiment of the present disclosure.

Referring to FIG. 15, the processor 170 of FIG. 5 may acquire state information of a passenger (S1100).

The processor 170 may acquire the state information of the passenger through at least one sensor provided in the vehicle.

The at least one sensor may be at least one camera provided in the vehicle 10. For example, the camera may be arranged to capture the passenger in the front direction, left and right directions. The processor 170 may analyze the second image acquired from the second camera to determine the glare state of the passenger.

The state information of the passenger may include at least one of the numbers of eyelid closure of the passenger, an open size of the eyelid, facial expression of the passenger, the gaze direction of the passenger acquired by analyzing the second image, and it may be used to determine a glare state of the passenger by analyzing the state information. For example, the movement speed of the eyelid may be determined as a glare state when the speed of blinking the eye exceeds a predetermined reference value or more. In addition, for example, the eye blinking depth may be measured, and the glare state may be determined based on the eye blinking depth when the eyes are awake. That is, the processor 170 may display an image acquired through the camera based on the numbers of eyelid closure of the passenger, an open size of the eyelid, facial expression of the passenger, the gaze direction of the passenger as a reference value, when the passenger is in a normal state without glare. By analyzing, the analysis result may be transmitted to the processor 170.

The processor 170 may determine the glare state of the passenger based on the state information of the passenger (S1110).

A detailed process of determining the glare state is omitted since it is substantially similar to determining the glare state of the driver described with reference to FIG. 7.

The determination of the glare state of the passenger based on the state information of the passenger may be performed in the vehicle 10, itself, or may be performed in the 5G network.

When the processor 170 recognizes the glare state of the passenger, the processor 170 may operate to block the primary light source (S1120).

The primary light source blocking may operate at least one of a sun visor, a curtain, and a sunshade mounted in the vehicle. For example, the primary light source blocking may include an operation of working the curtain or the sunshade (S1121).

Curtains or sunshades mounted on the vehicle may be placed near the side glass or the rear glass of the vehicle.

The processor 170 may detect a change in the facial expression of the passenger through a camera inside the vehicle to acquire the change in the facial expression of the passenger (S1130).

The processor 170 may extract feature points (eyes, eyebrows, lips, glasses, sunglasses, etc.) from the face image of the passenger captured through the camera. The processor 170 may detect the location of the feature point on the face coordinate system (x, y, z) generated based on the face center point. In this case, the face coordinate system may be generated based on an arbitrary point in the image rather than the face center point. The processor 170 may calculate the amount of movement of the face and the amount of rotation of the face in units of predetermined time based on a change in the position of the feature point on the face coordinate system according to the movement of the passenger's face. The amount of movement of the face may mean a distance of movement of the face generated by the movement of the body, and the amount of rotation of the face may mean a direction vector representing a biaxial rotation angle (Roll, Pitch Yaw). The processor 170 may store the position and direction vector of the passenger's face in real time, and a method of detecting the direction vector of the face may be implemented in various manners.

In addition, the processor 170 may determine the state of the passenger through the acquired facial expression change or the hand gesture of the passenger (S1140).

The processor 1710 may operate the second light source blocking when the facial expression of the passenger is being changed by the light source or the passenger hides the face by hand (S1150). Thereafter, the processor 170 may control the light source blocking device in the vehicle to block the secondary light source. The light source blocking device may be at least one of a curtain and a sunshade mounted in the vehicle.

According to an embodiment of the present disclosure, when the vehicle 10 confirms the glare state of the driver, the vehicle 10 may transmit a message related to the glare state of the driver to another vehicle through V2X communication. The V2X terminal installed in the vehicle 10 may exchange various messages through a V2X communication with a nearby V2X base station, a V2X terminal installed in another vehicle, a V2X terminal of a driver or a pedestrian, and the like. In addition, a portable V2X terminal of a driver or pedestrian may also exchange various messages through V2X communication with a nearby V2X base station, a V2X terminal installed in a vehicle, and the like.

According to an embodiment of the present disclosure, when the vehicle 10 confirms the glare state of the driver, the vehicle 10 may transmit a message related to the glare state of the driver to another vehicle through V2X communication.

The present disclosure described above may be implemented using a computer-readable medium with programs recorded thereon for execution by a processor to perform various methods presented herein. The computer-readable medium includes all kinds of recording devices capable of storing data that is readable by a computer system. Examples of the computer-readable mediums include hard disk drive (HDD), solid state disk (SSD), silicon disk drive (SDD), ROM, RAM, CD-ROM, a magnetic tape, a floppy disk, an optical data storage device, the other types of storage mediums presented herein, and combinations thereof. If desired, the computer-readable medium may be realized in the form of a carrier wave (e.g., transmission over Internet). Thus, the foregoing description is merely an example and is not to be considered as limiting the present disclosure. The scope of the present disclosure should be determined by rational interpretation of the appended claims, and all changes within the equivalent range of the present disclosure are included in the scope of the present disclosure.

What is claimed is:

1. A method for controlling light in an autonomous vehicle, the method comprising:
acquiring state information of a driver from a sensor located inside the vehicle;
determining a glare state of the driver based on the state information;
performing first light source blocking based on the determined glare state of the driver, wherein the first light source blocking includes operating a first light source blocking device;
tracking a gaze direction of the driver using a first image; and
performing second light source blocking, based on the tracked gaze direction of the driver being outside a predetermined range.

2. The method of claim 1, wherein the state information of the driver includes at least one of a number of eyelid closures of the driver during a defined time period, an open size of the eyelid, a facial expression of the driver, or the gaze direction of the driver.

3. The method of claim 1, further comprising:
extracting feature values from sensing information acquired through at least one sensor; and
inputting the feature values to an artificial neural network (ANN) classifier trained to distinguish whether the driver is in a normal state or the glare state, wherein the feature values are values that distinguish between a normal state and the glare state of the driver; and
performing the determining the glare state of the driver based further on an output of the artificial neural network.

4. The method of claim 1, further comprising:
acquiring a second image from a second camera located inside the vehicle;
acquiring state information of a passenger located in the vehicle based on the second image;
determining a glare state of the passenger based on the state information of the passenger;
operating the first light source blocking device based on the determined glare state of the passenger.

5. The method of claim 4, wherein the light source blocking device includes one of a sun visor, a curtain, or sunshade.

6. The method of claim 5, further comprising:
performing the first light source blocking by applying a primary filtering to a light source coming through a windshield of the vehicle using the sun visor positioned between the windshield of the vehicle and the driver, and
performing the second light source blocking by applying a secondary filtering to the light source, when the tracked gaze direction of the driver is out of the predetermined range.

7. The method of claim 5, further comprising:
displaying driving information on the sun visor, wherein the driving information is related to traveling direction of the vehicle.

8. The method of claim 7, wherein the driving information includes traffic lights, other vehicles, and pedestrians.

9. The method of claim 1, further comprising:
transmitting a vehicle-to-everything (V2X) message to another terminal in communication with the vehicle, wherein the V2X message includes information related to the glare state of the driver.

10. The method of claim 1, further comprising:
receiving a downlink control information (DCI) from a network, wherein the DCI is used to schedule transmission of state information of the driver obtained from at least one sensor located in the vehicle; and
transmitting the state information to the network based on the DCI.

11. The method of claim 10, further comprising:
performing an initial access procedure with the network based on a synchronization signal block (SSB); and
performing the transmitting the state information through a physical uplink shared channel (PUSCH),
wherein a demodulation reference signal (DM-RS) of the PUSCH of the SSB are a quasi-co-located (QCLed) for a QCL type D.

12. The method of claim 10, further comprising:
controlling a transceiver to transmit the state information of the driver to an artificial intelligence (AI) processor included in the network; and
controlling the transceiver to receive AI processed information from the AI processor,
wherein the AI processed information is information in which the state of the driver is determined as either the glare state or a normal state.

13. The method of claim 1, wherein the first light source blocking is primary light source blocking and the second light source blocking is secondary light source blocking.

14. An apparatus for an autonomous vehicle, the apparatus comprising:
a sensor located inside the vehicle;
a memory; and
one or more processors configured to:
acquire state information of a driver of the vehicle from the sensor;
store the state information in the memory;
determine a glare state of the driver based on the state information;
cause first light source blocking based on the determined glare state of the driver, wherein the first light source blocking includes operating a first light source blocking device;
track a gaze direction of the driver using a first image; and
cause second light source blocking, when the tracked gaze direction of the driver is outside a predetermined range.

15. The apparatus of claim 14, wherein the one or more processors are further configured to:
extract feature values from sensing information acquired through at least one sensor; and
input the feature values to an artificial neural network (ANN) classifier trained to distinguish whether the driver is in a normal state or the glare state, wherein the feature values are values that distinguish between a normal state and the glare state of the driver; and
perform the determine the glare state of the driver based further on an output of the artificial neural network.

16. The apparatus of claim 14, wherein the one or more processors are further configured to:
acquire a second image from a second camera located inside the vehicle;
acquire state information of a passenger located in the vehicle based on the second image;
determine a glare state of the passenger based on the state information of the passenger; and
operate the first light source blocking device based on the determine the glare state of the passenger.

17. The apparatus of claim 14, further comprising:
a transceiver, wherein the one or more processors are further configured to:
control the transceiver to receive a downlink control information (DCI) from a network, wherein the DCI is used to schedule transmission of state information of the driver obtained from at least one sensor located in the vehicle; and
control the transceiver to transmit the state information to the network based on the DCI.

18. The apparatus of claim 17, wherein the one or more processors are further configured to:
perform an initial access procedure with the network based on a synchronization signal block (SSB); and
control the transceiver to perform the transmit the state information through a physical uplink shared channel (PUSCH),
wherein a demodulation reference signal (DM-RS) of the PUSCH of the SSB are a quasi-co-located (QCLed) for a QCL type D.

19. The apparatus of claim 17, wherein the one or more processors are further configured to:
control the transceiver to transmit the state information of the driver to an artificial intelligence (AI) processor included in the network; and
control the transceiver to receive AI processed information from the AI processor,
wherein the AI processed information is information in which the state of the driver is determined as either the glare state or a normal state.
